(19) United States
(12) Patent Application Publication
(10) Pub. No.: US 2016/0124696 A1
(43) Pub. Date: May 5, 2016

(54) DOWNSAMPLED RENDERING OF WEB PAGE LOADS TO SAVE POWER

(71) Applicant: Qualcomm Innovation Center, Inc., San Diego, CA (US)

(72) Inventors: Shiu Wai Hui, Richmond Hill (CA); Stewart Chao, Markham (CA); Bojin Liu, San Diego, CA (US)

(21) Appl. No.: 14/923,543

(22) Filed: Oct. 27, 2015

Related U.S. Application Data
(60) Provisional application No. 62/074,458, filed on Nov. 3, 2014.

(51) Int. Cl. G06F 3/14

(52) U.S. Cl. CPC G06F 3/14

(57) ABSTRACT

Methods and apparatus for rendering web content are disclosed. The method includes counting a number of times, i, a particular percentage of on screen pixels are overwritten before a final complete version of the webpage is displayed, and storing the number of times, i, the on screen pixels are overwritten in connection with an identifier of the webpage. When the webpage is requested again, the number of times, i, the on screen pixels were overwritten is retrieved using the identifier of the webpage, and down sampling is performed during N updates when loading the webpage, wherein N is less than i.

### CLAIM OF PRIORITY UNDER 35 U.S.C. §119

The present Application for Patent claims priority to U.S. Provisional Application No. 62/074,458 entitled “DOWNSAMPLED RENDERING OF WEB PAGE LOADS TO SAVE POWER” filed Nov. 3, 2014, and assigned to the assignee hereof and hereby expressly incorporated by reference herein.

### FIELD OF THE INVENTION

The present invention relates to computing devices. In particular, but not by way of limitation, the present invention relates to apparatus and methods for improving the rendering of content on computing devices.

### BACKGROUND OF THE INVENTION

Computing devices such as smartphones, netbooks, gaming devices, PDAs, desktop computers, televisions, and laptop computers are now ubiquitous. And these devices now very commonly include hardware that provides network connectively to web servers and software (e.g., web browsers) that provide an interface for users to request and view content from these web servers.

When a web page is being loaded by a web browser, due to the potentially long time it takes to get and process all the data from the Internet, the browser often displays an incomplete version of the page with content that is already loaded and processed while the rest of the page is being loaded. This way, the user can start viewing part of the webpage instead of seeing a blank screen. Very often these incomplete versions of the webpage are displayed for only a short period of time. Yet they are still computationally expensive (and use a lot of power) to render.

The webpage rendering process includes 1) performing a layout of the page; 2) converting the laid out HTML elements into graphics elements; 3) rasterizing graphics elements into bitmaps using a graphics library; and 4) compositing the bitmaps onto the screen. These steps are done for each incomplete version of the webpage during a page load, as well as for the final completely loaded version of the webpage. This involves significant processing and increased power usage. Rasterizating, for example, is especially intensive for a central processing unit (CPU). Some web browsers alleviate this problem by displaying fewer numbers of incomplete versions of the webpage. But this solution forces the users to look at a blank (or almost blank) window during page load.

### SUMMARY

An aspect of the invention may be characterized as a method for rendering a webpage with a computing device. The method includes requesting the webpage via a browser of the computing device, counting a number of times, i, a particular percentage of on screen pixels are overwritten before a final complete version of the webpage is displayed, and storing the number of times, i, in connection with an identifier of the webpage. When the webpage is requested again, the identifier of the webpage is utilized to obtain the number of times, i, the on screen pixels were overwritten, and then down sampling of the requested webpage is performed during N updates when loading the webpage, where N is less than i.

Another aspect may be characterized as a computing device that includes a transceiver to send a request for a webpage and to receive the webpage, a rendering component to convert elements of the webpage into graphics elements and rasterize the graphics elements into bitmaps, a compositing component to composite the bitmaps, and a display to display the composited bitmaps. The computing device also includes a down sampling component configured to down sample the graphics elements to rasterize the graphics elements into smaller bitmaps while incomplete versions of the webpage are rendered and composited.

Yet another aspect may be characterized as a non-transitory, tangible computer readable storage medium, encoded with processor readable instructions to perform a method for rendering a webpage with a computing device. The method includes requesting the webpage via a browser of the computing device, counting a number of times, i, a particular percentage of on screen pixels are overwritten before a final complete version of the webpage is displayed, and storing the number of times, i, in connection with an identifier of the webpage. When the webpage is requested again, the identifier of the webpage is utilized to obtain the number of times, i, the on screen pixels were overwritten, and then a down sampling of the requested webpage is performed during N updates when loading the webpage, where N is less than i.

### BRIEF DESCRIPTION OF THE DRAWINGS

FIG. 1 is a block diagram depicting a computing device according to aspects of the present invention;

FIG. 2 is a is a flowchart depicting a method that may be traversed in connection with embodiments disclosed herein; and

FIG. 3 is a block diagram depicting physical components of an exemplary computing device.

### DETAILED DESCRIPTION

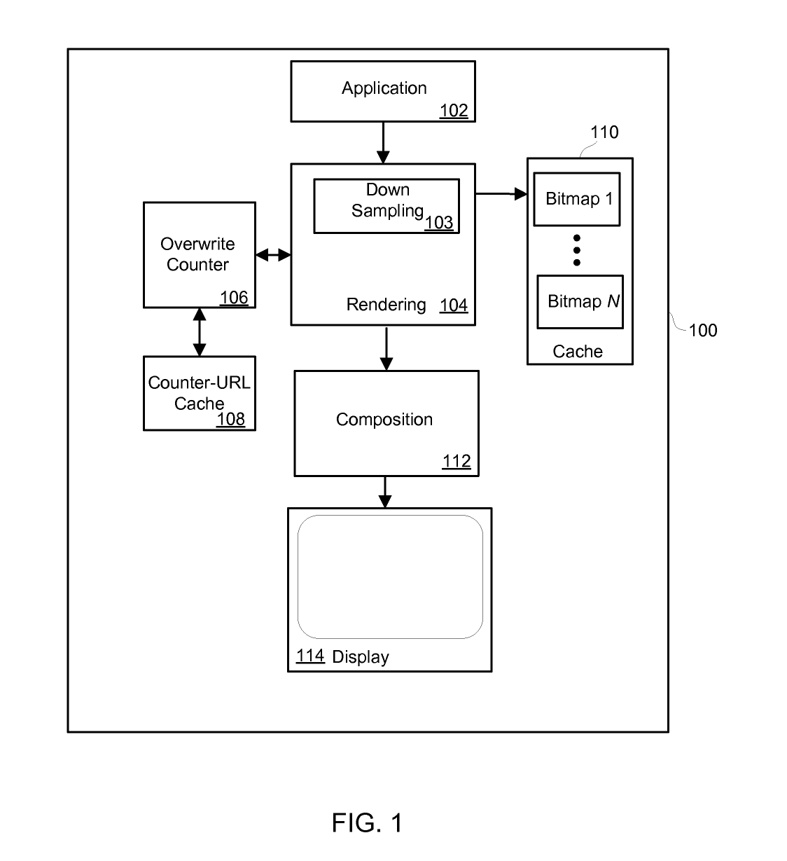

Referring first to FIG. 1, it is a block diagram depicting an embodiment of an exemplary computing device 100. As discussed further herein, the exemplary computing device 100 provides an improved user experience and/or reduced power consumption by reducing processing and power usage. For example, embodiments perform a slight down sampling when rendering an incomplete webpage during rasterization and compositing. More specifically, the webpage is scaled down and rasterized into smaller bitmaps. While down sampling is commonly done by browsers to reduce blanking during scrolling, implementations disclosed herein are different in that down sampling is performed for the incomplete versions of the webpage while the webpage is loading. In some embodiments, the down sampling factor is close to one (e.g., 0.8), which results in a quality degradation that is very hard to detect on a high-screen-resolution device. In variations, the browser may perform down sampling only for the incomplete versions of the webpages.

As shown, the computing device 100 includes an application 102 in communication with a rendering component 104 that is in communication with an overwrite counter 106 and a cache 110 that includes bitmap images. As depicted, a composition component 112 is in communication with the rendering component 104 and provides an output that is displayed by a display 114. As shown, a counter-URL cache 108 is coupled to the overwrite counter 106, and the rendering component 104 includes a down sampling component 103.

The depiction of these components is logical and is not intended to be an actual hardware diagram. For example, the division of browser-engine-related components (e.g., the rendering component 104, down sampling component 103, overwrite counter 106, counter-URL cache 108, and composition component 112) is for exemplary purposes only, and each depicted component may be further separated into constituent components. But it should also be recognized that the components may be integrated to such an extent that each component may not be separately recognizable in actual implementation. Moreover, the components may be realized by hardware, software in connection with hardware, firmware, or a combination thereof. And although not required, the down sampling component 103 and the overwrite counter 106 may be realized by additions and modifications readily apparent to one of ordinary skill in the art (in light of this disclosure) to an existing browser engine. For example, a Webkit engine may be modified to include the down sampling component 103 and overwrite counter 106 discussed herein.

The computing device 100 may be realized by a variety of devices such as smartphones, netbooks, gaming devices, PDAs, desktop computers, televisions, tablets, and laptop computers, and the application 102 may be any of a variety of applications that a user interacts with to request, retrieve and view web page content such as a web browser, or any of a variety of other applications that utilize webpage content (e.g., gaming, utility, and educational apps).

The rendering component 104 generally functions to receive web page objects from the application 102 and transform the received objects of the content into a raster. For example, the rendering component 104 transforms bitmap graphics, vector graphics and text that make up a webpage into a raster that can be displayed on screen. A typical webpage may have more than 150 objects to render, which may include one or more backgrounds, scripting-language objects (e.g., JavaScript), HTML objects, CSS objects, JPEGs, PNGs, and video objects.

For example, the rendering component 104 receives and decodes image objects (e.g., JPEG, PNG, GIF, TIFF objects) to generate the bitmap representations of the received image objects that are placed in the cache 110. And the bitmap images are retrieved from memory and composited by the composition component 112. For example, the bitmap images may be composited in a manner (e.g., in a sequential display) that provides the appearance of animation to the user.

The down sampling component 103 generally operates to perform a down sampling of objects in a requested webpage when rendering an incomplete version of the webpage during rasterization and compositing; thus reducing a demand for processing resources, which reduces power consumption. Although down sampling is beneficial while incomplete versions of a webpage are being displayed, it is generally difficult to know how many incomplete versions of a webpage will be displayed, if at all.

If the very first version of the webpage is already complete (e.g., the page is simple and is loading very fast), then there will be wasted processing on the low quality rendering of the webpage. Conversely, if the number of incomplete versions of the webpage is underestimated, time may be wasted rendering incomplete versions of the webpage in high quality. The present embodiment improves performance in instances where a webpage has been previously loaded on the computing device 100.

As a consequence, in the present embodiment, when a webpage is loaded for the first time, the overwrite counter 106 count the number i of times a significant percentage of the onscreen pixels are overwritten before the display of the final complete version of the webpage. What is considered “significant” may be determined by a threshold. For example, a threshold percentage may be 50% before the update is considered significant enough to increment the overwrite counter i. As depicted, the overwrite counter 106 records the number i (along with an identifier for the webpage) in a persistent counter-URL cache 108. On subsequent loads of the webpage, the rendering component 104 reads the recorded number i for that webpage from the counter-URL cache 108. If the number i is above a threshold, the down sampling component 103 estimates a number N of full screen updates that occur before the final complete version of the web page is displayed.

For example, if the overwrite counter, i, is two, the down sampling component 103 will expect that there will be two incomplete versions of the webpage to be displayed. The estimate is then further lowered to account for the fact that subsequent page loads are generally faster. The final estimate is conservative to reduce the chance of generating low quality rendering of the final complete webpage. Given the estimate N, the down sampling component 103 performs down sampling when rendering during N page overwrites (also referred to herein as updates); thus achieving power savings.

If the estimate N is too small, some intermediate updates are rendered in high quality; thus reducing power savings. If the estimate N is too big, the browser may have rendered the final version of the web page in low quality, thus requiring an additional repaint in high-quality (HQ). In such a case, the browser can optionally schedule an HQ update with low priority, so that it is done after all other processing in the browser is done, or if the user starts scrolling or zooming the page, the browser will further postpone the HQ update with the expectation that the low quality (LQ) rendering may get invalidated (e.g., scrolled off screen, zoomed) anyway so no re-generation in HQ is necessary. In some implementations, the counter-URL cache 108 entries may get invalidated if one or more of the following occurs: an expiration time has passed; more space is needed for new entries; and page loads of a particular URL did not include intermediate updates.

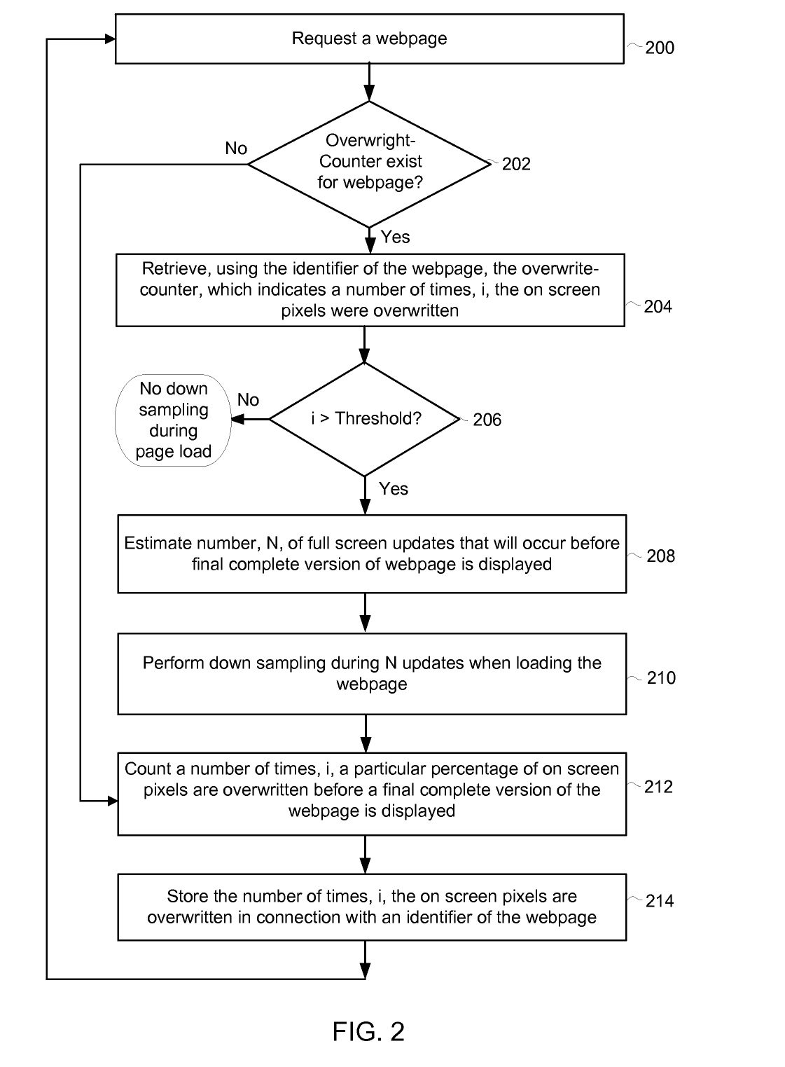

Referring next to FIG. 2, shown is a flowchart depicting a method that may be traversed in connection with the embodiment depicted in FIG. 1. As shown, when a webpage is requested by a user of the computing device 100 (Block 200), if the webpage has been visited before and an overwrite counter, i, has been generated (by the overwrite counter 106) and stored in the counter-URL cache 108 (Block 202), then the overwrite counter is retrieved from the counter-URL cache 108 using an identifier for the webpage (Block 204). In many implementations, a uniform resource locator (URL) is utilized as the identifier for the webpage, but it is contemplated other identifiers (e.g., an IP address) may be utilized as an identifier for the webpage.

As discussed above, the overwrite counter is indicative of a number of times, i, screen pixels were overwritten during a previous loading of the webpage. As discussed above and further herein, in many implementations an update (also referred to as an overwrite) only increments i if a threshold number of pixels were overwritten. For example, the threshold number of pixels may be 50% of pixels so that if an update only overwrites 40% of the displayed pixels then i is not incremented. Although 50% is a viable threshold in some implementations, it is contemplated that this threshold is configurable (e.g., based upon empirical analysis).

As shown in FIG. 2, in some embodiments no down sampling occurs if the stored overwrite counter, i, is below a threshold (Block 206). It is contemplated that this threshold may be configurable, but beneficial results have been realized when the threshold of Block 206 is set to either two or three.

If i is above the threshold (Block 206), then in general, down sampling is generally beneficial, but subsequent page loads are generally faster because content for a particular webpage may already be cached on the computing device 100, and the cached content may be recently-cached content that need not be obtained from a remote network to render the webpage. As a consequence, in many embodiments, instead of performing down sampling for i updates when the webpage is downloaded, down sampling is performed during fewer than i updates.

In some embodiments for example, an estimate of the number N of actual updates that will occur is carried out based upon the overwrite counter, i (Block 208), and down sampling is performed during the N updates while loading the webpage (Block 210). In some implementations for example, N is calculated to be less than i. More specifically, N may be calculated to be a particular number (e.g., 1 or 2) less than i. In other variations, the amount of cached content for the webpage and how recently the cached content was obtained are factors that are used to adjust N. In general, the final estimate N is conservative to reduce the chance of generating low quality rendering of the final complete webpage.

As one of ordinary skill in the art, in view of this disclosure, will appreciate, the down sampling may be performed during the rasterization process to reduce the size of the resulting bitmaps. For example, an image that would ordinarily by rasterized to a bit map of 100 pixels may instead be rasterized to 80 pixels or 70 pixels. In many implementations a down sampling factor is selected to result in relatively little down sampling so that a user of today's high display resolution devices is unlikely to realize down sampling has occurred. The down sampling factor, for example, may be 0.8, but other down sampling factors such as 0.6, 0.7, 0.9 and others therebetween may be utilized.

As shown in FIG. 2, if an overwrite counter does not exist for a requested webpage (Block 202), a number of times, i, a particular percentage of on screen pixels are overwritten is counted before a final complete version of the webpage is displayed (Block 212). If the webpage is being loaded for the first time (so there is no overwrite counter in the counter-URL cache 108), an overwrite counter is stored in connection with an identifier for the webpage at Block 214. But if an overwrite counter does exist for the requested webpage (Block 202), then the number of times, i (a particular percentage of on screen pixels are overwritten before a final complete version of the webpage is displayed) is used to update the overwrite counter, i, stored in the counter-URL cache 108 at Block 214.

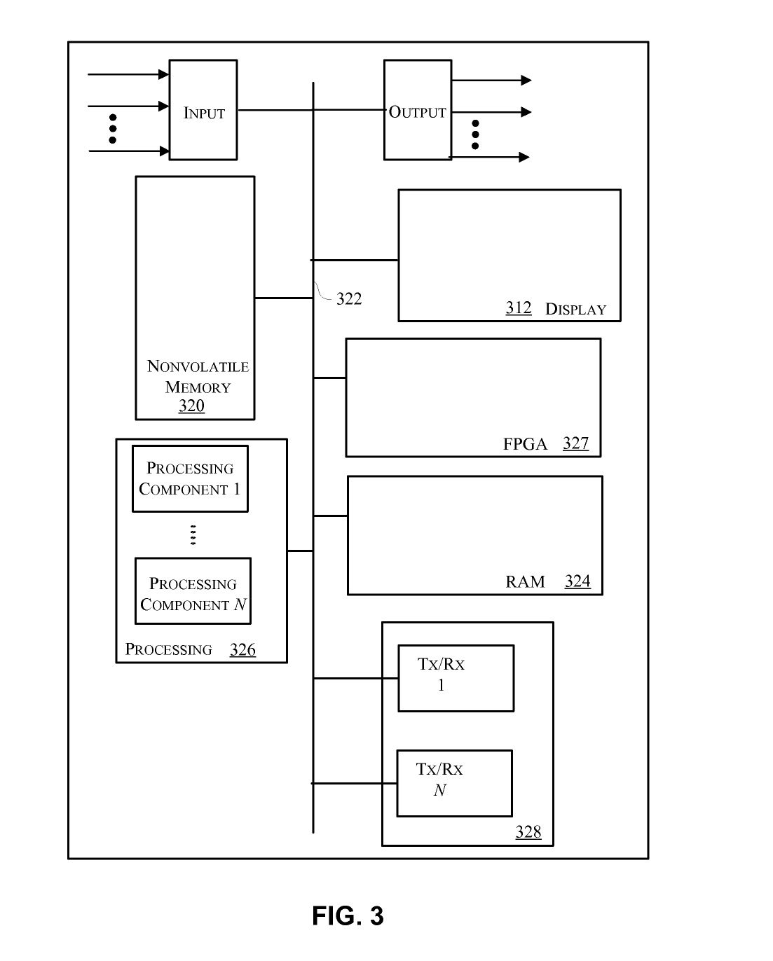

Referring next to FIG. 3, shown is a block diagram depicting physical components that may be utilized to realize one or more aspects of the embodiments disclosed herein. As shown, in this embodiment a display 312 and nonvolatile memory 320 are coupled to a bus 322 that is also coupled to random access memory (“RAM”) 324, a processing portion (which includes N processing components) 326, a field programmable gate array (FPGA) 327, and a transceiver component 328 that includes N transceivers. Although the components depicted in FIG. 3 represent physical components, FIG. 3 is not intended to be a detailed hardware diagram; thus many of the components depicted in FIG. 3 may be realized by common constructs or distributed among additional physical components. Moreover, it is contemplated that other existing and yet-to-be developed physical components and architectures may be utilized to implement the functional components described with reference to FIG. 3.

The display 312 generally operates to provide a user interface for a user. The display 312 may be realized, for example, by an LCD or AMOLED display, and in several implementations, the display 312 is realized by a touchscreen display. The display 312 may be utilized to realize, at least in part, the display 114 described with reference to FIG. 1 to display webpages (and down sampled versions of webpages while webpages are loading). In general, the nonvolatile memory 320 is non-transitory memory that functions to store (e.g., persistently store) data and processor executable code (including executable code that is associated with effectuating the methods described herein). In some embodiments for example, the nonvolatile memory 320 includes bootloader code, operating system code, file system code, and non-transitory processor-executable code to facilitate the execution of functional components depicted in FIG. 1 and the methods described herein including the method described with reference to FIG. 2. Moreover, the non-volatile memory may be utilized to realize the counter-URL cache 108 described with reference to FIG. 1.

In many implementations, the nonvolatile memory 320 is realized by flash memory (e.g., NAND or ONENAND memory), but it is contemplated that other memory types may be utilized as well. Although it may be possible to execute the code from the nonvolatile memory 320, the executable code in the nonvolatile memory is typically loaded into RAM 324 and executed by one or more of the N processing components in the processing portion 326.

The N processing components in connection with RAM 324 generally operate to execute the instructions stored in nonvolatile memory 320 to enable the loading and rendering of webpages. For example, non-transitory processor-executable instructions to effectuate the methods described with reference to FIG. 2 may be persistently stored in nonvolatile memory 320 and executed by the N processing components in connection with RAM 324. As one of ordinarily skill in the art will appreciate, the processing portion 326 may include a video processor, digital signal processor (DSP), graphics processing unit (GPU), and other processing components.

In addition, or in the alternative, the FPGA 327 may be configured to effectuate one or more aspects of the methodologies described herein (e.g., the methods described with reference to FIG. 2). For example, non-transitory FPGA-configuration-instructions may be persistently stored in nonvolatile memory 320 and accessed by the FPGA 327 (e.g., during boot up) to configure the FPGA 327 to effectuate functions of one or more of the components depicted in FIG. 1 including the down sampling component 103 and overwrite counter 106.

The depicted transceiver component 328 includes N transceiver chains, which may be used for communicating with external devices via wireless or wireline networks. Each of the N transceiver chains may represent a transceiver associated with a particular communication scheme (e.g., WiFi, CDMA, Bluetooth, NFC, etc.). The transceiver chains may be utilized to request and receive webpages and send form data as described herein. In many embodiments, the computing device 100 is a wireless computing device that utilizes wireless transceiver technology, but the computing device 100 may also be implemented using wireline technology.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

FIG. 3 depicts an example of constructs that may be utilized to implement embodiments disclosed herein, but the various illustrative logical blocks, modules, and circuits described in connection with the embodiments disclosed herein may be implemented or performed in a variety of different ways. For example, the various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

1. A method for rendering a webpage with a computing device, the method comprising:
requesting the webpage via a browser of the computing device;
counting a number of times, i, a particular percentage of on screen pixels are overwritten before a final complete version of the webpage is displayed;
storing the number of times, i, the on screen pixels are overwritten in connection with an identifier of the webpage;
requesting the webpage again;
retrieving, using the identifier of the webpage, the number of times, i, the on screen pixels were overwritten; and
performing down sampling during N updates when loading the webpage, wherein N is less than i.

2. The method of claim 1, wherein performing down sampling includes performing down sampling only if i exceeds a threshold.

3. The method of claim 1, wherein N is an estimate of updates that will occur before a final complete version of the webpage is displayed.

4. The method of claim 3, wherein N is calculated to be a number less than i.

5. The method of claim 3 wherein N is estimated based upon an amount of cached content for the webpage.

6. The method of claim 5, wherein N is estimated based upon an amount of time the cached content for the webpage has been on the computing device.

7. The method of claim 1, wherein the particular percentage of on screen pixels that are overwritten before i is incremented is at least 50%.

8. The method of claim 1, wherein a down sampling factor of greater than 6 is utilized to perform the down sampling.

9. A computing device, the computing device including:
a transceiver to send a request for a webpage and receive the webpage;
a rendering component to convert elements of the webpage into graphics elements and rasterize the graphics elements into bitmaps;
a compositing component to composite the bitmaps;
a display to display the composited bitmaps; and
a down sampling component configured to down sample the graphics elements to rasterize the graphics elements into smaller bitmaps while incomplete versions of the webpage are rendered and composited.

10. The computing device of claim 9, including:
an overwrite counter configured to count and store a number of times, i, the webpage is overwritten, wherein the down sampling component is configured to down sample graphics elements into smaller bitmaps during N updates when loading the webpage a subsequent time, wherein N is less than i.

11. A non-transitory, tangible computer readable storage medium, encoded with processor readable instructions to perform a method for rendering a webpage with a computing device, the method comprising:
requesting the webpage via a browser of the computing device;
counting a number of times, i, a particular percentage of on screen pixels are overwritten before a final complete version of the webpage is displayed;
storing the number of times, i, the on screen pixels are overwritten in connection with an identifier of the webpage;
requesting the webpage again;
retrieving, using the identifier of the webpage, the number of times, i, the on screen pixels were overwritten; and
performing down sampling during N updates when loading the webpage, wherein N is less than i.

12. The non-transitory, tangible computer readable storage medium of claim 11, wherein performing down sampling includes performing down sampling only if i exceeds a threshold.

13. The non-transitory, tangible computer readable storage medium of claim 11, wherein N is an estimate of updates that will occur before a final complete version of the webpage is displayed.

14. The non-transitory, tangible computer readable storage medium of claim 13, wherein N is calculated to be a number less than i.

15. The non-transitory, tangible computer readable storage medium of claim 13, wherein N is estimated based upon an amount of cached content for the webpage.

16. The non-transitory, tangible computer readable storage medium of claim 15, wherein N is estimated based upon an amount of time the cached content for the webpage has been on the computing device.

17. The non-transitory, tangible computer readable storage medium of claim 11, wherein the particular percentage of on screen pixels that are overwritten before i is incremented is at least 50%.

18. The non-transitory, tangible computer readable storage medium of claim 11, wherein a down sampling factor of greater than 7 is utilized to perform the down sampling.
